(19) United States
(12) Patent Application Publication
(10) Pub. No.: US 2011/0168692 A1
(43) Pub. Date: Jul. 14, 2011

(54) ELECTRICAL HEATING ELEMENT AND A METHOD FOR ITS PRODUCTION

(75) Inventors: Klauss Assman, Nurnberg (DE); Armin Barnert, Roth (DE)

(73) Assignee: HE SYSTEM ELECTRONIC GMBH & CO. KG, Veitsbronn (DE)

(21) Appl. No.: 12/987,719

(22) Filed: Jan. 10, 2011

(30) Foreign Application Priority Data
Jan. 11, 2010 (DE) 102010000042.6

(51) Int. Cl. H05B 3/10; H01C 17/02

(52) U.S. Cl. 219/553; 29/611

(57) ABSTRACT

The invention relates to an electrical heating element which is in the form of a flat piece and has the following layers: a first ceramic substrate in a burnt state, a resistance layer composed of a resistance material which is applied to the first ceramic substrate, a low-melting-point glass layer, which completely covers the resistance layer 16, such that the resistance layer is an integral component of the glass layer, and a second ceramic substrate in a burnt state, which completely covers the glass layer. The invention also relates to a method for its production.

### CROSS-REFERENCE TO RELATED APPLICATIONS

The present invention claims the benefit of priority to German Patent Application NO. DE 10 2010 000 042.6, filed Jan. 11, 2010, entitled “Elektrisches Heizungselement und ein Verfahren zu dessen Herstellung,” the entire content of which is incorporated by reference herein.

### BACKGROUND OF THE INVENTION

1. The Field of the Invention

The invention relates to an electrical heating element which is in the form of a flat piece. The invention also relates to a method for its production.

2. Background and Relevant Art

By way of example, electrical heating elements may be in the form of heaters, supplementary heaters or additional heaters, and it should be possible to produce them at least comparatively easily, to operate them as reliably as possible, and for them to be as resistant to wear as possible.

Electrical heating elements such as heaters, supplementary heaters or additional heaters may, according to the prior art, comprise, for example, a mount element composed of steel or ceramic, for example ceramic tubes, which is printed with F a resistance material. Lacquered or sintered layers are generally applied for protection against environmental influences.

DE 35 45 267 A1 describes a flat heating element which can be heated by current. The flat heating element consists of a non-conductive mount and an electrically conductive layer which is applied flat to it and acts as resistance heating. The electrically conductive layer is formed from a thick film which is applied in the pasty state. However, the flat heating element has a low withstand voltage and a short life as well.

EP 0 914 021 B1 discloses a ceramic heating element having two ceramic layers, in which a resistance heating element is embedded between the ceramic layers. The resistance heating element is composed substantially of metal. The two ceramic layers are provided as powder pressings and are then sintered. Temperatures of more than 1500° C. are required for sintering. In addition, special tools are required. This method is therefore complex and expensive. Furthermore, shrinkage occurs during the sintering process, as a result of which the dimensional tolerances which can be achieved are more than 1%, which is unacceptable for most applications.

### BRIEF SUMMARY OF THE INVENTION

Implementations of the present invention are based on providing an electrical heating element and of specifying a method for its production, by means of which the abovementioned disadvantages are overcome.

With regard to the electrical heating element, the object is achieved by the subject matter as claimed.

According to the invention, an electrical heating element is provided, which is in the form of a flat piece and has the following layers:
a first ceramic substrate in a burnt state,
a resistance layer composed of a resistance material which is applied to the first ceramic substrate,
a low-melting-point glass layer which is connected to the resistance layer,
a second ceramic substrate in a burnt state, which is connected to the glass layer.

The low-melting-point glass layer preferably completely or at least virtually completely covers the resistance layer, such that the resistance layer is particularly preferably an integral component of the glass layer.

The second ceramic substrate preferably completely or at least virtually completely covers the glass layer and/or the second ceramic substrate is fused to the glass layer.

The second ceramic substrate allows a high electrical withstand voltage. Electrical voltages of more than 500 V are possible. Complete coverage of the resistance layer by the glass layer, as is preferably provided, allows heat to be introduced uniformly into the second ceramic substrate. The layer structure makes the heating element more mechanically robust. The heating element is protected against environmental influences by the arrangement between the ceramic substrates.

In one preferred embodiment of the invention, the first and/or the second ceramic substrate are/is produced from aluminum oxide (Al2O3). In particular, it is possible to use commercially available Al2O3 substrates in the burnt state. These are available, in particular, with the dimensions 4″×4″ or 4″×6″. The heating element can thus be produced using conventional materials.

Furthermore, the resistance layer can be produced from a resistance paste. In this case, the resistance paste may have particles which, for example, have a grain size between 2 μm and 5 μm.

The glass layer can preferably comprise a material having a melting point between 500° C. and 700° C. The low-melting-point glass layer completely covers the resistance layer, and is used as a connecting element for the second ceramic substrate.

The object on which the invention is based in respect of the method is achieved by the subject matter as claimed.

According to the invention, the method for production of an electrical heating element, in particular in the form of a flat piece, comprises the following steps:
provision of a first ceramic substrate in a burnt state,
application of a resistance layer composed of a resistance material to the first ceramic substrate,
application of a low-melting-point glass layer to the resistance layer, with the glass layer being connected to the resistance layer,
attachment of a second ceramic substrate in a burnt state.

The resistance layer is preferably completely or at least virtually completely covered by the glass layer, such that the resistance layer is particularly preferably an integral component of the glass layer.

The second ceramic substrate is preferably connected, in particular fused, to the glass layer.

The attachment of the second ceramic substrate results in a layer structure which allows improved mechanical robustness and a high electrical withstand voltage. Electrical voltages of more than 500 V are possible. Complete coverage of the resistance layer by the glass layer, as is preferable, allows heat to be introduced uniformly into the ceramic substrate. The heating element is protected against the environmental influences by the arrangement between the ceramic substrates.

In one preferred embodiment, the first and/or the second ceramic substrate are/is produced from aluminum oxide (Al2O3). Conventional Al2O3 substrates in the burnt state can therefore be used. In particular, these are available with the dimensions 4″×4″ or 4″×6″. This allows the heating element to be produced using commercially available materials.

In particular, a material having a melting point between 500° C. and 700° C. is used for the glass layer. The low-melting-point glass layer on the one hand completely covers the resistance layer, and on the other hand acts as a connecting element for the second ceramic substrate.

The resistance layer, composed of a pasty material, is preferably applied to the first ceramic substrate. The resistance paste generally has particles which, for example, have a grain size between 2 μm and 5 μm.

Finally, conductor tracks for further electrical and/or electronic components, and/or further electrical connections, can also be applied by printing with the resistance layer.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The invention will be explained in more detail using one preferred exemplary embodiment and with reference to the attached drawings, in which:

FIG. 1 shows a plan view of a heating element according to one preferred embodiment of the invention, and

FIG. 2 shows a side section view of the heating element according to the preferred embodiment of the invention.

### DETAILED DESCRIPTION OF THE PREFERRED EMBODIMENTS

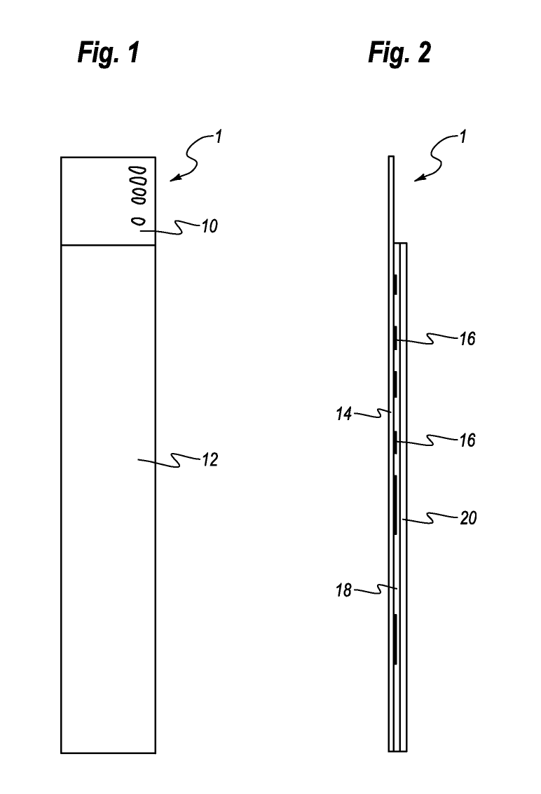

FIG. 1 shows a plan view of a heating element according to one preferred embodiment of the invention.

The heating element 1 has a first area 10 with electrical connections, and preferably with an electronic circuit for open-loop and/or closed-loop control of the heating element. The heating element 1 furthermore has a second area 12 with the actual heating element.

In this specific embodiment, the heating element 1 together with the first and second areas 10 and 12 has a total length of 152 mm, and a width of 24.5 mm. The second area 12, that is to say the actual heating element, in this example has a length of 126.5 mm and a width of 24.5 mm.

FIG. 2 shows a side section view of the heating element 1 according to the preferred embodiment of the invention. FIG. 2 shows the layer structure of the heating element according to the invention. FIG. 2 illustrates the layer thickness of the heating element as being considerably thicker than in an illustration which is true to scale.

The heating element 1 comprises a first ceramic substrate 14, a resistance layer 16, a low-melting-point glass layer 18, and a second ceramic substrate 20.

The first ceramic substrate 14 is produced in a burnt state, and preferably from aluminum oxide (Al2O3).

The resistance layer 16 is composed of a resistance material. The resistance layer is preferably produced from a resistance paste. The resistance paste may have particles which have a grain size between 2 μm and 5 μm. The resistance of the resistance layer 16 is, for example, about 120Ω.

The glass layer 18 is composed of a low-melting-point glass. The melting point is preferably between 500° C. and 700° C. The resistance layer 16 is an integral component of the glass layer 18.

In this specific embodiment, the second ceramic substrate 20 preferably has the same characteristics as the first ceramic substrate 14, and is connected, in particular, fused, to the glass layer 18.

In this specific embodiment, the first ceramic substrate 14 and the second ceramic substrate 20 have a layer thickness of 0.635 mm. In this example, the glass layer 18 has a layer thickness of 0.075 mm. In this embodiment, the resistance layer 16 has a layer thickness of 0.02 mm. In this case, the resistance layer 16 is integrated in the glass layer 18, such that the 0.02 mm of the resistance layer 16 is included in the 0.075 mm of the glass layer 18. In this embodiment, the overall layer thickness of the heating element is 1.345 mm.

The electrical heating element according to the invention and the method for its production allow more mechanical robustness, an increased electrical withstand voltage, and protection of the heating element against environmental influences. The heating element can be treated with a laser, for further processing.

The laser treatment may in this case relate either to mechanical shaping or else to adjustment of the resistance value. In this case, the resistance value is adjusted before the glass layer and/or the second ceramic layer are/is applied.

In particular, the heating element according to the invention may be a heater, an additional heater or a supplementary heater.

There are a range of different fields of application for the electrical heating element according to the invention. These include, for example, appliances, in particular domestic appliances, such as hair dryers or fan heaters.

Furthermore, the electrical heating element according to the invention can be used for heating systems in vehicles. By way of example, use in trains or motor vehicles may be mentioned in this context.

By way of example, the waste heat from the internal combustion engine has often been used exclusively in the past for heating of motor vehicles. In more modern vehicles, the waste heat from the internal combustion engine has often been reduced considerably. In order to improve the comfort, in particular in motor vehicles, the electrical heating element according to the invention can therefore also be used as an additional heater or supplementary heater.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### LIST OF REFERENCE SYMBOLS

1 Heating element
10 First area of the heating element
12 Second area of the heating element
14 First ceramic substrate
16 Resistance layer
18 Glass layer
20 Second ceramic substrate

We claim:

1. An electrical heating element which is in the form of a flat piece and has the following layers, comprising:
a first ceramic substrate in a burnt state;
a resistance layer composed of a resistance material which is applied to the first ceramic substrate;
a low-melting-point glass layer which is connected to the resistance layer; and
a second ceramic substrate in a burnt state, which is connected to the glass layer.

2. The electrical heating element as claimed in claim 1, wherein:
the low-melting-point glass layer completely covers the resistance layer, such that the resistance layer is preferably an integral component of the glass layer; and/or
the second ceramic substrate completely or at least virtually completely covers the glass layer; and/or
the second ceramic substrate is fused to the glass layer.

3. The electrical heating element as claimed in claim 1, wherein:
the first and/or the second ceramic substrate are/is produced from aluminum oxide (Al2O3); and/or
the resistance layer is produced from a resistance paste.

4. The electrical heating element as claimed in claim 1, wherein the glass layer comprises a material with a melting point between 500° C. and 700° C.

5. The electrical heating element as claimed in claim 1, wherein the first and/or the second ceramic substrate have/has solder pads.

6. A method for production of an electrical heating element comprising the following steps:
provision of a first ceramic substrate in a burnt state;
application of a resistance layer composed of a resistance material to the first ceramic substrate;
application of a low-melting-point glass layer to the resistance layer, with the glass layer being connected to the resistance layer; and
attachment of a second ceramic substrate in a burnt state.

7. The method as claimed in claim 6, wherein:
the resistance layer is completely covered by the glass layer such that the resistance layer is preferably an integral component of the glass layer; and/or
the second ceramic substrate is connected, in particular fused, to the glass layer.

8. The method as claimed in claim 6, wherein:
the first and/or the second ceramic substrate are/is produced from aluminum oxide (Al2O3); and/or
a material with a melting point between 500° C. and 700° C. is used for the glass layer.

9. The method as claimed in claim 6, wherein the resistance layer, composed of a pasty material, is applied to the first ceramic substrate.

10. The method as claimed in claim 6, wherein conductor tracks for further electrical and/or electronic components and/or further electrical connections are also applied with the resistance layer.
